(19) United States
(12) Patent Application Publication
(10) Pub. No.: US 2013/0173926 A1
(43) Pub. Date: Jul. 4, 2013

(54) Method, Apparatus and Applications for Biometric Identification, Authentication, Man-to-Machine Communications and Sensor Data Processing

(71) Applicants: Francesco Antonio Morese, Mountain View, CA (US); David J. Sullivan, San Francisco, CA (US); David K. Varn, San Jose, CA (US)

(72) Inventors: Francesco Antonio Morese, Mountain View, CA (US); David J. Sullivan, San Francisco, CA (US); David K. Varn, San Jose, CA (US)

(73) Assignee: OLEA SYSTEMS, INC., Campbell, CA (US)

(21) Appl. No.: 13/565,782

(22) Filed: Aug. 2, 2012

Related U.S. Application Data
(60) Provisional application No. 61/514,654, filed on Aug. 3, 2011.

(51) Int. Cl. G06F 19/10

(52) U.S. Cl. CPC G06F 19/10
USPC 713/186

(57) ABSTRACT

Applications, algorithms and technologies are disclosed for machine-to-machine communications, biometric identification and sensor data fusion. Applications include authentication, e-commerce and energy management. Algorithms include biometric signature generation and identification, as well as data fusion methods. Technologies include biometric and environmental sensing and identification. Advantages of the invention include more robust person authentication, greater immunity to theft of personal property and information, and enhanced building energy management.

### CROSS REFERENCE TO RELATED APPLICATIONS

This application claims priority under 35 USC §119(e) to U.S. Provisional Patent Application No. 61/514,654, filed Aug. 3, 2011, titled “Method, Apparatus and Applications for Man-to-Machine Communications and Sensor Data Processing,” the entire contents of which are herein incorporated by reference.

### FIELD OF THE INVENTION

The present invention generally relates to the fields of machine-to-machine communications and biometrics, and more specifically, to methods and apparatus for processing information from sensors and humans, and applications thereof.

### BACKGROUND

During the past several decades, the field of electronic communications has evolved rapidly. With the advent of the Arpanet, later the Internet, basic electronic messaging applications based on Internet Protocol, such as email and telnet, became widely available to anyone with a computer and a modem. Interpersonal and commerce-oriented communications and applications, most notably hypertext-based browsers utilizing the World Wide Web, rapidly accelerated, thanks to expansion of infrastructure and the advent of higher level applications.

E-Commerce applications developed to enable users to conduct purchases and financial transactions remotely based on personal authentication methods. Authenticating a person involves verifying that the person actually is whom he or she purports to be. In e-commerce applications, the identity of a user should be remotely verified before completing a transaction. One system that has evolved to support this is the Public Key Infrastructure, or PKI. PKI comprises methods, technologies and techniques that together provide a secure infrastructure. PKI uses a public and private key pair for authentication. No one should be able to access another's private key, so access to private keys is generally protected with a password of the owner's choice. PKI's main problem is the management of private keys. They need to be stored somewhere like a PC, a server, or smart card, etc. and be protected with a password. Accessing a private key requires knowledge of the password, not being the right person, so the PKI method is vulnerable to attacks by hackers. A description of this can be found in Shahriar Mohammadi and Sanaz Abedi, ECC-Based Biometric Signature: A New Approach in Electronic Banking Security, International Symposium on Electronic Commerce and Security, 2008.

The “next wave” accommodates electronic communications between humans and machines as well as among machines themselves, and is often referred to as “man-to-machine” and “machine-to-machine,” both abbreviated “M2M.” Man-to-machine applications range from basic security access using wireless key FOBs to ever-expanding applications based on Smart Phones and other personal digital appliances. In a typical scenario, machine-to-machine communication uses a device such as a sensor or observation device to capture information or an event, such as temperature, status information, etc., which is transmitted through a network (e.g., wireless, wired or hybrid) to inform an application such as a software program. The application translates the captured event into some type of meaningful information or instruction, for example, that temperature needs to be increased or items need to be restocked. This is accomplished through the use of a language that the machines use to intercommunicate. It is estimated that the potential exists for intercommunication among 50 billion machines, a number outstripping global human population by nearly an order of magnitude. A description of this can be found in “M2M: The Internet of 50 Billion Devices”, WinWin Magazine, January 2010.

Modern M2M communication has evolved to enable networks to carry data between machines and personal appliances. The expansion of wireless networks worldwide has expedited this and has lessened the amount of power and time required. These factors enable new applications and connections between humans and machines. Examples range from building environmental control to applications supporting the evolving Smart Grid. A description of this can be found in “How Machine-to-Machine Communication Works,” HowStuffWorks.com, and in “When Machines Speak,” InfoWorld.

While the field of M2M communications promises exciting new prospects, it simultaneously presents a number of challenges. A vast array of legacy protocols and standards must be supported, encompassing wired and wireless techniques as well as a broad array of networking practices. Large-scale M2M systems might comprise thousands of sensors and other devices, each having unique protocols and other requirements, and each producing substantial amounts of data. Traditionally, such sensors have been physically and electrically disparate, such that individual sensors need to be separately mounted and electrically connected. Information communication to and from such sensors may be simplified by using wireless transmission and networking technology, which can be especially attractive in legacy scenarios. Nonetheless, as the number of sensors in a given installation increases, the tasks of managing their operation and data output can become prohibitively complex. Furthermore, modern sensors may be amenable to control, for example, receiving commands to vary their sensitivity, orientation and other characteristics. Thus, there is thus a need for techniques that can efficiently manage the complexity of M2M systems, both in terms of information processing and control.

M2M functionality is an aspect of modern energy and building management systems (BMSs).¹ BMSs are most commonly applied in large buildings. Among other tasks, BMSs manage the internal environment and may control lighting, temperature, carbon dioxide levels and humidity. Most BMSs control heating, cooling and air flow throughout the building and maintain desired room temperatures. BMSs sometime also monitor the level of human-generated CO₂, mixing outside air with internal waste air to increase oxygen level while minimizing hot or cold air loss. BMSs may link to access control or other security systems such as fire alarm systems and elevators. For example, if a fire is detected then the system could close ventilation dampers to stop smoke from spreading and send all elevators to the ground floor to prevent people from using them. ¹ http://en.wikipedia.org/wild/Building_management_system

Systems linked to a BMS typically represent 40% of a building's energy usage; if lighting is included, this number approaches 70%. BMSs are critical to managing large building energy usage. Poorly configured BMSs are believed to account for 20% of building energy usage, or approximately 8% of total energy usage in the United States, clearly a substantial amount.² There is thus a need for improved BMS technology that will increase effectiveness and reduce loss. ² ibid

Meanwhile, the field of biometrics has experienced significant growth. Biometrics comprises methods for uniquely recognizing or accommodating humans based upon intrinsic physical or behavioral traits, such as fingerprint or retina patterns or cardiac-derived signatures. A biometric is a “measurable physiological and/or behavioral trait that can be captured and subsequently compared with another instance at the time of verification.” Biometrics can be used to authenticate and identify an individual by processing his/her biometric information. A biometric identifier derives from “something the user is,” and can be created from fingerprints, retina or iris scans, hand geometry, voice patterns, vein patterns or any other such technologies. Biometric data can be collected by a sensor device, and a reference signature can be generated therefrom and stored in a database. For each attempted identification, a corresponding biometric sample is collected from the individual and a new signature is created. This signature is then compared with the reference signature and a decision made to accept or reject the claimed identity based on a comparison threshold. A description of this can be found in Anoop Miss., “Elliptic Curve Cryptography, An implementation Tutorial,” Tata Elxsi Ltd, Thiruvananthapuram, India; and in V. Zorkadis, P. Donos, “On biometrics-based authentication and identification from a privacy protection perspective: Deriving privacy-enhancing requirements,” Information Management & Computer Security, Vol. 12 No. 1, 2004, pp. 125-137.

It is known that the human heart bears a signature that is unique to the individual. Such a “heart signature” can be captured using a variety of techniques, such as electrocardiogram (ECG), echocardiogram (ultrasound-based), Doppler RADAR, laser Doppler vibrometry and other means. Wireless cardiac biometric identification is considered advantageous compared to other biometric methods in that identity can be determined without physically invasive measures or even cooperation by the subject. A description of identity determined via ECG can be found in Irvine, et al., “eigenPulse: Robust Human Identification from Cardiovascular Function,” Pattern Recognition, Vol. 41, 2008, pp 3427-3435.

The convergence of M2M and biometrics promises a wealth of new or improved applications. Security and e-Commerce applications can benefit from the ability to determine or authenticate a person's identity without the need for personal passwords, PIN codes, FOBs etc. that can be forgotten, lost, stolen or otherwise compromised. Energy management systems can benefit from knowledge of the identity of human inhabitants and of their personal preferences. For example, if a particular occupant of an office building desires unique heating, cooling, lighting conditions etc, those needs can potentially be better accommodated while eliminating unneeded lighting, heating etc.

While straightforward in principle, practical biometric-based identification and security systems can be compromised by a number of factors. For example, age, emotional state, fatigue and so forth can alter some aspects of cardiac-based signatures. Security measures that rely on fingerprints, retina scans and the like can be spoofed by applying surreptitiously obtained counterfeit signatures.

From the above, there is a need for improved methods, apparatus and applications that will further the evolution of M2M and biometric identification systems and techniques, and that furthermore will gracefully and effectively enable their convergence.

### SUMMARY

The present invention includes technologies, algorithms and applications that relate to M2M communications and biometric sensing, authentication and identification. Applications include secure physical access and E-commerce applications that build upon authentication methods to enable secure transactions such as purchases, financial transactions and so on. Energy management for buildings also makes use of biometric identification as well as M2M communication.

A person may be “scanned,” that is, illuminated with electromagnetic energy, such as microwave or other radio frequency electromagnetic energy, and a reflected version of such energy processed. The reflected energy bears a phase modulation relative to the incident energy based on motion of some portion of the person's anatomy, typically of the chest or back, such as results from cardiac and/or pulmonary motion. Data sequences are produced based on such modulation, and authentication tokens are generated in turn from the data sequences. A first “embedded” authentication token may be generated by a trusted authority to serve as a master, or reference token, and this embedded token may be stored in a network or database. When the person wishes to conduct a transaction or gain physical access, a subsequent “authentication token” is generated and compared to the embedded token. If a match occurs, the person is authenticated, that is, declared to be whom he or she purports to be, and the transaction or access is allowed. The tokens may be generated by encrypting the data sequence also may be stored within or transmitted over a network.

Such techniques may similarly serve to identify a person by, for example, comparing a person's authentication token with a plurality of embedded tokens corresponding to a plurality of persons. If a match is found between the authentication token and a particular embedded token, the person is identified, that is, declared to be the person to whom the matching embedded token belongs.

Such techniques may be used exclusively or combined with legacy biometric techniques. For example, a person may be authenticated based on a combination of sensing chest motion and fingerprint pattern. Other biometrics may be similarly combined, such as, for example, electrocardiogram, laser Doppler vibrometry, retina scan, facial feature and so on. Persons skilled in the art will appreciate that many such combinations are possible.

Mobile, eCommerce and other online transactions may be enhanced using the above techniques. For example, a person may be scanned by a trusted authority such as a bank or other financial institution, a passport authority, driver license bureau and so on to generate an embedded token as discussed above. When the person wishes to conduct a transaction from an appliance such as an automated teller machine, a smartphone, a computer laptop or tablet and so on, the appliance can scan the individual to produce an authentication token. The authentication token can then be compared with the embedded token. If the tokens match, the person is authenticated, and the transaction is enabled.

These operations may involve other types of appliances such as credit/debit cards, passports and so on. Each such appliance, if used, can store an additional pre-generated embedded authentication token which may also be compared to the locally-generated/real-time authentication token. A personal digital appliance such as a smartphone can perform a real-time scan to create the local authentication token. The techniques discussed above can function in the context of a variety of network and device architectures as will be described below.

According to one embodiment, an algorithm/system for biometric identification comprises an analysis network such as an artificial neural network (NN) or other adaptive network. The analysis network trains or adapts on stored or realtime biometric data sequences derived from biometric sensors of any type. After the adaptive network substantially convergences, functional datasets that capture the converged parameters of the adaptive network, such as tap weights etc., are stored in a functional dataset library. This library may be populated with multiple functional datasets corresponding to multiple biometric capture methods. After this library has been created, functional datasets can be applied to a fixed network for subsequently generating biometric signatures from newly conducted biometric scans.

Data fusion techniques that support the above and other applications comprise functions such as data formatting, combining, abstracting, decimating, resampling, estimating etc. Such techniques can advantageously manage the voluminous data produced from sensors within large-scale systems such as may be found in industrial or military applications. The methods and algorithms disclosed are capable of functioning on dedicated implementations or on a general purpose computer.

The above applications and algorithms in turn build upon a sensor technology foundation. Of particular interest are biometric sensors, especially Doppler radar-based “heart signature” sensors that are particularly sensitive to cardiac activity. Such a sensor can be employed to generate a “radar seismocardiogram,” or R—SCG, resulting from motion of the heart or motion of the chest or back resulting from cardiac activity. Radio waves are reflected and received from a person's heart or chest or back surface. Doppler modulation results from cardiac and pulmonary activity directly or from resultant chest displacement. The Doppler modulation is sensed and processed to provide a cardiac signature that is unique to the individual.

The above methodology offers a number of significant advantages for the applications discussed. A person may be authenticated based on his or her unique biometric characteristics, and thus risk of compromise based on lost or stolen passwords or PINs is eliminated. Biometric scanning can be accomplished either by infrastructure equipment or by a personal digital appliance such as a mentioned above and equipped with a biometric scanning device. Other applications resident on the personal digital appliance can securely process the requisite transactions. The user's identity is kept secure, and thus transaction security is improved. If a card, personal digital appliance, identification number, digital certificate etc. is corrupted, lost or stolen, the likelihood of compromise of critical personal information is reduced or eliminated, since the person must be present at the time of the transaction and must bear his or her unique biometric signature.

Indoor energy management may also make use of biometric signatures. For example, an integrated sensor pod may comprise environmental sensors that generate environmental descriptors for characterizing ambient temperature, light, carbon dioxide level etc., and may also comprise biometric sensors for identifying occupants. The pod's mechanical design can provide flexibility in mounting and orientation of the individual sensors. Energy management systems can thereby benefit substantially. Integrated sensor pods may be conveniently installed in new or legacy environments, and individual sensor outputs may be processed to manage the volume of information produced. Personal digital appliances such as smart phones may be connected, and may provide additional environmental and biometric sensors and serve as control appliances.

An information fusion platform may receive the fused sensor information pertinent to a portion or all of a building and in turn control a building management system (BMS). Energy-related resources within the environment heating, lighting, and so on can be controlled via respective resource control parameters and resource status parameters. Such arrangement is capable of intelligently optimizing comfort, utility and energy expense, and can additionally help to manage emergency situations. Variables such as changing external light, real-time demand response profiles and changes in staffing and room occupancy may be taken into consideration. The information fusion platform can be integrated with other systems such as building security etc. Using the identification techniques described above, individuals' presence and preferences can be taken into account to optimize comfort and cost. Additional, applying such techniques can support emerging Smart Grid-related functions such as Demand Response.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The Figures (“FIG.”) and the following description relate to preferred embodiments of the present invention by way of illustration only. Wherever practicable, similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

FIG. 1 illustrates a data fusion platform according to one embodiment of the present invention.

FIG. 2 illustrates a sensor pod according to one embodiment of the present invention.

FIG. 3 illustrates a data and information fusion platform according to one embodiment of the present invention.

FIG. 4 illustrates an integrated sensor pod according to one embodiment of the present invention.

FIG. 5 illustrates a method for managing resources within a room or area of a building according to one embodiment of the present invention.

FIG. 6 illustrates a conceptual hierarchy according to one embodiment of the present invention.

FIG. 7 illustrates a computer system according to one embodiment of the present invention.

FIG. 8(a) illustrates a wireless Doppler radar according to one embodiment of the present invention.

FIG. 8(b) illustrates a waveform according to one embodiment of the present invention.

FIG. 9 illustrates an automated teller machine according to one embodiment of the present invention.

FIG. 10(a) illustrates a method for obtaining a functional dataset according to one embodiment of the present invention.

FIG. 10(b) illustrates a method for obtaining a biometric signature according to one embodiment of the present invention.

FIG. 11(a) illustrates a flowchart for a method for obtaining a functional dataset library according to one embodiment of the present invention.

FIG. 11(b) illustrates a flowchart for a method for obtaining a biometric signature library according to one embodiment of the present invention.

FIG. 12(a) illustrates a method for obtaining an authentication token according to one embodiment of the present invention.

FIG. 12(b) illustrates a method for authentication according to one embodiment of the present invention.

FIG. 12(c) illustrates a method for authentication via a network according to one embodiment of the present invention.

FIG. 13 illustrates information processing within an automated teller machine according to one embodiment of the present invention.

FIG. 14(a) illustrates a method for conducting general e-commerce transactions according to one embodiment of the present invention.

FIG. 14(b) illustrates a method for conducting e-commerce transactions over a network according to one embodiment of the present invention.

FIG. 15 illustrates a methodology for sensor data fusion according to one embodiment of the present invention.

### DETAILED DESCRIPTION OF THE PREFERRED EMBODIMENTS

Reference will now be made in detail to several embodiments of the present invention, examples of which are illustrated in the accompanying figures. One skilled in the art will readily recognize that alternative embodiments of the structures and methods illustrated herein may be employed without departing from the principles of the invention described. For purposes of explanation, numerous specific details are set forth in order to provide a thorough understanding of the invention. It will be apparent, however, to one skilled in the art that the invention can be practiced without these specific details.

Reference to “one embodiment” or “an embodiment” means that a particular feature, structure, or characteristic described in connection with the referenced embodiment is included in at least one embodiment of the invention. The appearances of the phrase “in one embodiment” in various places do not necessarily all refer to the same embodiment.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, flash memory devices, magnetic or optical cards, or any type of media suitable for storing electronic instructions.

### Architecture Description

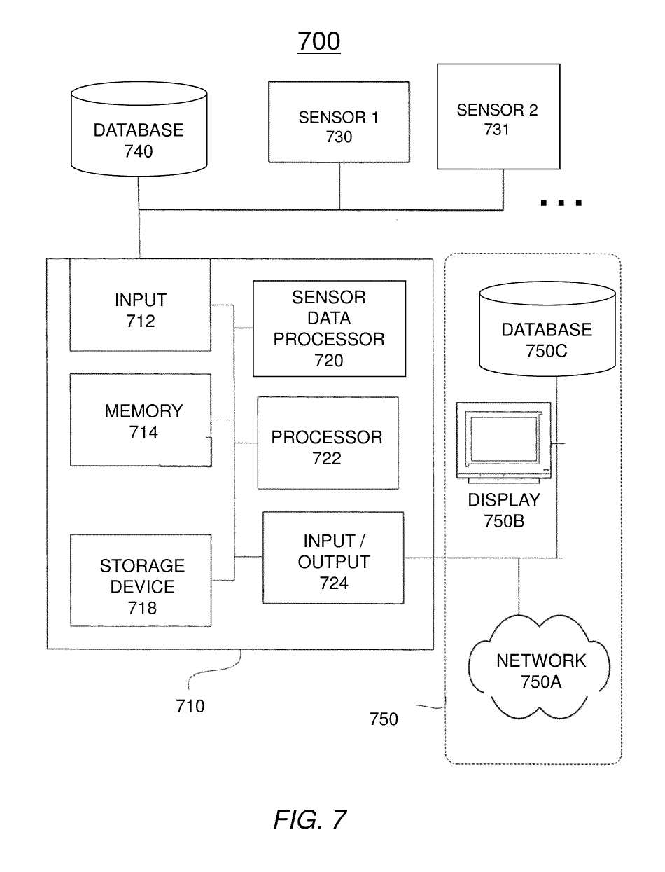

FIG. 7 shows a system 700 according to one embodiment of the present invention. Computer system 710 comprises an input module 712, a memory device 714, a storage device 718, a processor 722, and an output module 724. In an alternative embodiment, a sensor data processor 720 is dedicated to processing sensor information such as information derived from a biometric sensor in a preferred manner. Memory device 714 may be a standalone memory device or a memory on-chip with processor 720 or 722 (e.g., cache memory). Storage device 718 may be any bulk storage device such as a hard disk, flash drive, DVD-R/RW, CD-R/RW or RAM. Computer system 710 can be a stand-alone system, such as, a server, a personal computer, workstation or the like. Alternatively, computer system 710 can be part of a larger system, for example, an automatic teller machine (ATM), an automobile, an enterprise banking or financial system computer, a building energy management system, and so on.

Input module 712 receives digital information from a database 740. Input module 712 may also receive digital information directly from a sensing device 730, for example, a biometric sensor, a video system (e.g., closed circuit television), an image, retina or fingerprint scanner, or the like. Alternatively, input module 712 may be an interface to receive information from a network system, for example, another database, another biometric sensor system, Internet servers, or the like. The network interface may be a wired interface, such as, a USB, RS-232 serial port, Ethernet card, or the like, or may be a wireless interface module, such as a device configured to communicate using a wireless protocol, e.g., Bluetooth, WiFi, IEEE 802.11, or the like. Sensor data processor 720 could be used to pre-process biometric information received through input module 712 to convert the digital information to the preferred format that processors 720 and/or 722 operate.

Information is stored in the memory device 714 to be processed by either of processors 720 and 722. Processor 722 applies a set of instructions that when executed perform one or more of the methods according to the present invention, e.g., implementing a biometric analysis or sensor data processing or fusion algorithm. Memory device 714 may, e.g., include a module of instructions for implementing such methods.

Processor 722 may output information through input/output module 724 to an external device 750, e.g., a network element or server 750a, a display device 750b, a database 750c or the like. As with input module 712, output module 724 can be wired or wireless. Output module 724 may be a storage drive interface, (e.g., hard-drive or optical drive driver), a network interface device (e.g., an Ethernet interface card, wireless network card, or the like), or a display driver (e.g., a graphics card, or the like), or any other such device for outputting the information determined. In addition, output module 724 may interface appropriately with other systems such as an enterprise computing system, an ATM, an automobile, a banking or financial computer system, a building energy management system, and so on.

### Sensor Technologies

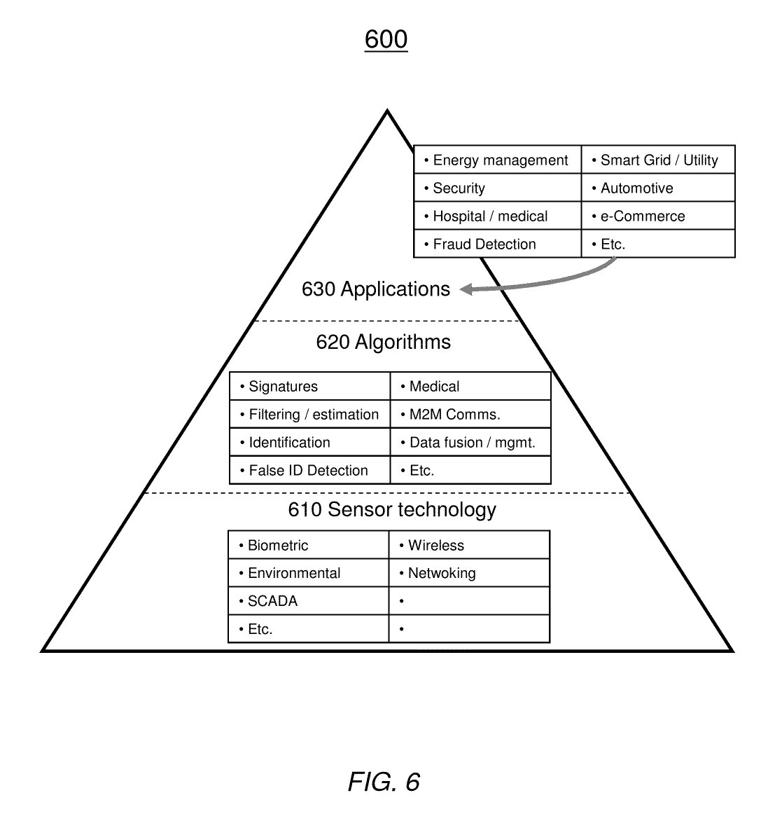

Referring now to FIG. 6, a conceptual hierarchy is depicted. At the base level 610 is shown a field of exemplary sensors and related technologies that may variously comprise systems to be described. Biometric sensors may characterize, for example, fingerprints, retina patterns, and perspiration. Cardiac-related information may be obtained via a variety of techniques, including laser Doppler vibrometry, electrocardiogram (ECG) and echocardiogram. These may be considered invasive, as they require the subject to either assume a particular orientation relative to the detection apparatus, or be physically/electrically connected. The algorithm 620 and application 630 spaces of hierarchy 600 will be described below.

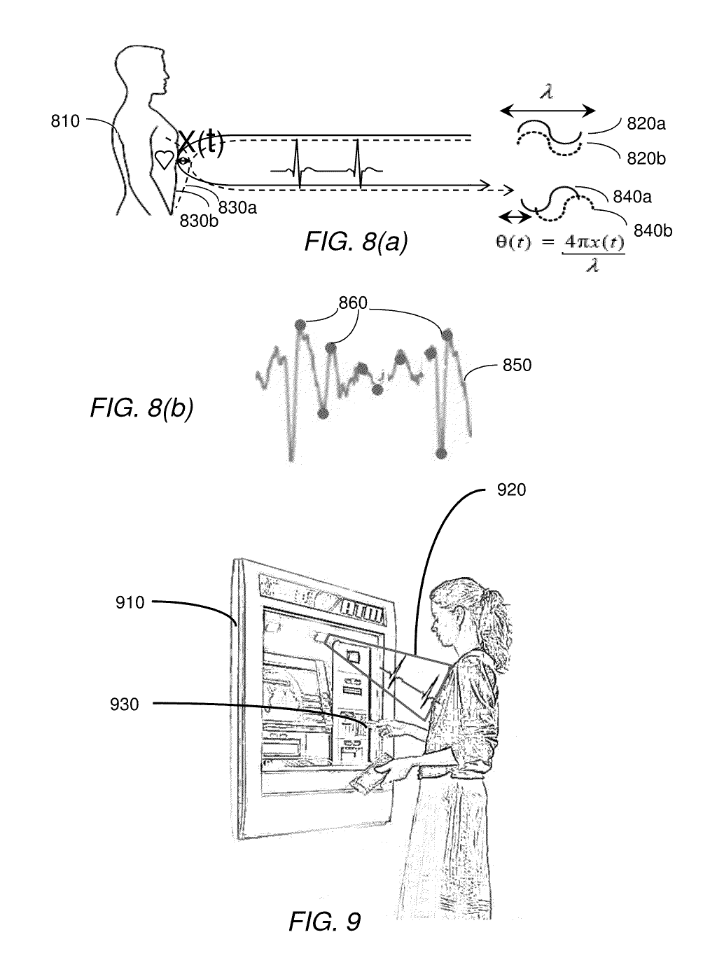

Referring now to FIG. 8(a), Wireless Doppler radar may be used to obtain a cardiac signature. According to one embodiment of the present invention, a radio wave 820a having a reference phase 820b is radiated towards an individual's chest and is reflected back towards the source. The chest undergoes lateral translation, e.g., 830a-b according to the individual's breathing and cardiac activity. The reflected wave 840a-b bears a relative phase variation or modulation OW with the lateral translation 830a-b. This phase modulation can be processed to obtain a waveform representative of the individual's cardiac motion. Such a waveform is shown conceptually in FIG. 8(b) as waveform 850. In practice, waveform 850 may be continuous or may be sampled.

As will be described in greater detail below, waveform 850 can be further analyzed to extract key features that are unique to the subject. Such a set of features is referred to as a cardiac biometric signature, and for simplicity is depicted conceptually as the set of points 860 taken from overall waveform 850. In one embodiment, points 860 may be actual sample points of waveform 850. Points 860 may be otherwise derived as well. The amount of information required to describe points 860 may considerably less than that required to describe or reproduce overall waveform 850. Further description of this can be found in Boric-Lubecke et al., Amplitude Modulation Issues in Doppler Radar Heart Signal Extraction, BioWireleSS 2011.

Referring now to FIG. 4, a conceptual diagram for an integrated sensor pod 400 is depicted according to one embodiment of the present invention. Individual sensors 402, 405, 406, 407 and 408 are secured within housings such as housing 404. The housings are in turn mounted on a common frame 403. The sensors may provide information regarding a variety of ambient conditions, such as, for example, temperature, humidity, pressure, carbon dioxide/monoxide, light level and so on. One or more sensors may be devoted to sensing biometric information regarding a person or persons in the vicinity. The sensors may be active, that is, powered, or passive. The sensors' data and power connections if any terminate in node 401. The data so transmitted may be in analog or digital format, and may be continuous or sampled. Node 401 may provide various functionality, such as, for example, analog-to-digital (A/D) conversion, format conversion, multiplexing, switching, bridging, routing, wireless transmission/networking and so on. Node 401 may serve other purposes, such as, for example, enabling wireless data communications for local computers or other devices according to a variety of standards such as IEEE 802.11 etc.

Frame 403 may be variously shaped to allow the various sensors to attain unique fields of view, and the various interconnections may be flush mounted or concealed under frame 403. The resultant physical and electrical integration can greatly simplify both installation and power and data management, while the physical co-location of the individual sensors can provide advantageous reporting of correlated conditions. For example, ambient temperature and light level can be reported for a common area. Such integration and correlation can be particularly amenable to data fusion techniques that are discussed below. The relative orientations and described functions of the various devices on pod 400 are illustrative, and many other variations are possible.

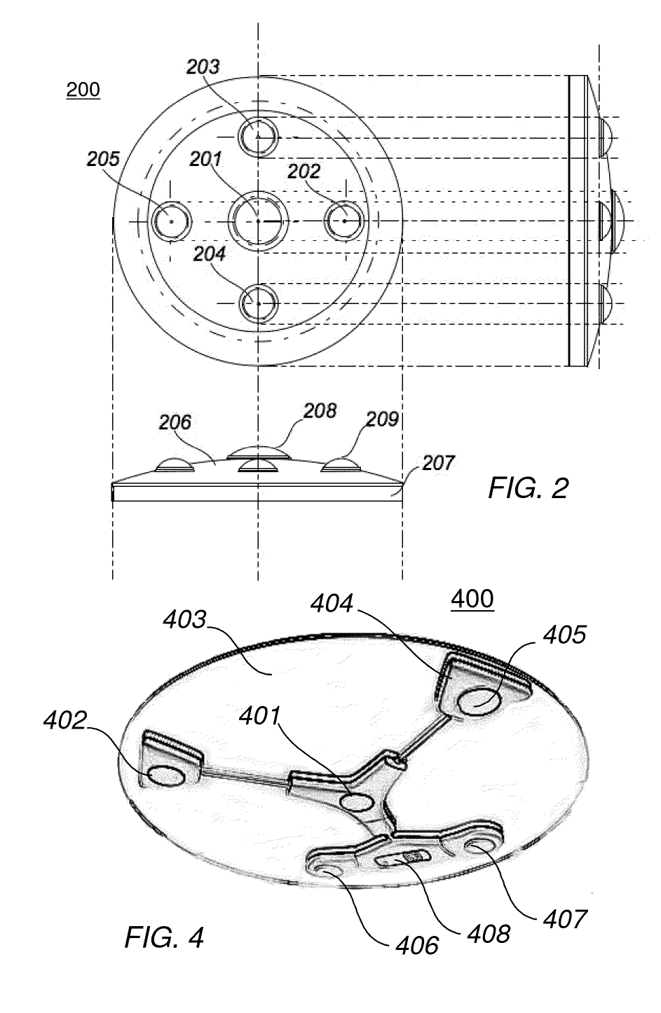

Now referring to FIG. 2, a mechanical drawing of an alternate physical embodiment 200 of a sensor pod is shown. Modules 201-205 and 208-209 may each serve as sensors or nodes as described above, and may be individually adjusted physically and/or electrically to optimize the respective fields of view. Mounting fixture 207 can be adapted to accommodate pod frame 206 according to various mounting strategies. In addition to monitoring ambient conditions, sensor pods 200 and 400 may include sensors to collect biometric data, such as, for example, cardiac biometric signature sensors that serve as a basis for identification of individual subjects.

Other sensor technologies are available to serve M2M applications as well. For example, Supervisory control and data acquisition (SCADA) systems typically monitor and control industrial, infrastructure, or facility-based processes. A SCADA System usually acquires data on and sends commands to a process. Remote Terminal Units (RTUs) connect to sensors placed within the process, and typically convert various sensor signals to digital data and send such data to the supervisory system. An array of sensors may be employed measure or evaluate such things as temperature, pressure, flow rate, status etc. A communication infrastructure generally connects the supervisory system to the RTUs.³ ³ http://en.wikipedia.org/wiki/SCADA

### Algorithms

Referring again to FIG. 6, built upon sensor technology 610 is a layer of algorithms 620. These algorithms typically receive information produced by the sensors of level 610 and refine, abstract or fuse, that is, combine, the sensor information. Such operations may constitute end goals such identifying a person, detecting a false identification instrument such as a counterfeit passport, or presenting biometric information for medical monitoring or diagnostic purposes. On the other hand, various algorithms 620 may comprise intermediary functionality towards supporting higher level applications 630, as will be discussed below.

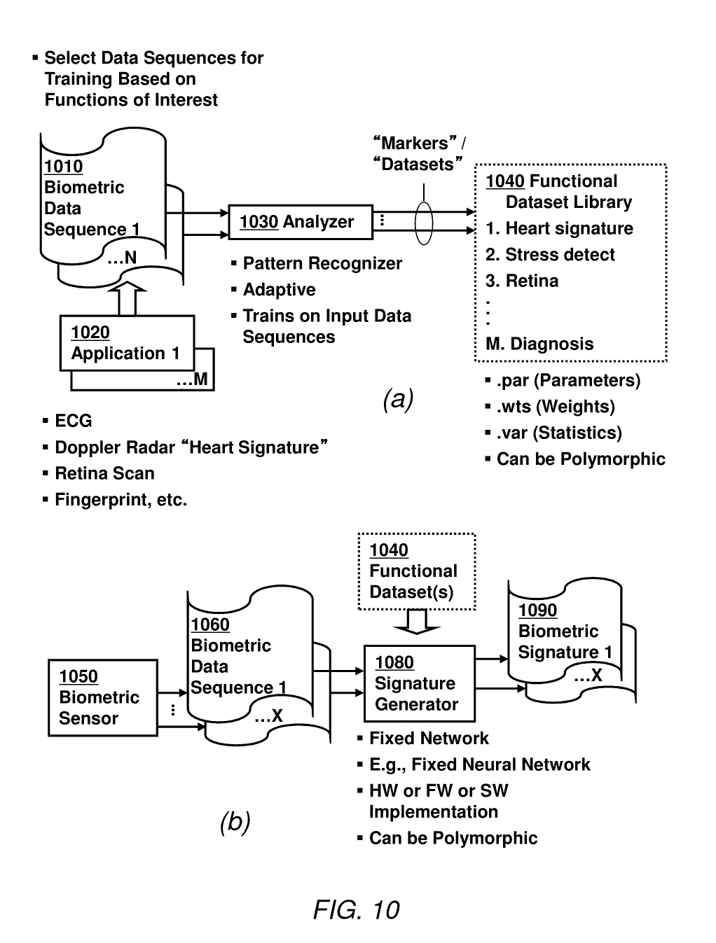

Signature algorithms can receive sensor information and identify patterns or particular sources therefrom. Of interest are algorithms that identify human subjects from information produced by biometric sensors. According to one embodiment of the present invention, the method depicted in FIG. 10 can be used to accomplish such identification. Referring now to FIG. 10(a), a set of biometric data sequences 1010 have been generated from biometric sensors. Biometric data sequences 1010 may have been collected in real time or from a database according to an application of interest 1020. The collected biometric data sequences are then used to train an analyzer 1030 that has been configured to perform pattern recognition as will be discussed below. For example, the application of interest 1020 may be recognizing individuals based on ECG or cardiac-derived Doppler radar signatures as discussed above. In such case, the set of N biometric data sequences 1010 is a set of such ECG or cardiac-derived Doppler radar signatures collected from a population of human subjects. The number N may vary depending on data availability, the desired confidence in the results and on the convergence properties of analyzer 1030. In practice, N may vary from tens to thousands of data sequences. Analyzer 1030 is then configured to train, or converge, on the chosen set 1010. Analyzer 1030 may be any of a variety of adaptive networks for performing pattern recognition, such as, for example, an artificial neural network (ANN) or a Bayesian network. An example of a pattern recognition algorithm adapted to perform cardiac signature analysis can be found in Irvine, et al., which is referenced above. Irvine, et al. found that based on their methodology, over eighty percent of individual heartbeats could be correctly classified, while nearly 100 percent of individuals could be correctly classified based on voting from the heartbeat classification.

An ANN comprises a network of simple processing elements that can exhibit complex overall behavior, as determined by the connections between the processing elements and element parameters.⁴ In an ANN simple nodes, referred to variously as “units” or “Processing Elements” (PEs), are connected to form a network. An ANN's utility flows from algorithms that alter the strength of weights in the network so as to produce a desired signal flow. ANNs can infer a function from observations and then implement such function. Unsupervised ANNs can adapt to capture the salient characteristics of the input distribution. Learning ANNs are particularly useful in applications where the complexity of the data or task makes the direct design of such functions impractical. ⁴ http://en.wikipedia.org/wiki/Neural_network

ANNs can be applied to tasks falling within several broad categories, including: function approximation, or regression analysis, including time series prediction and modeling; classification, including pattern and sequence recognition; novelty detection; sequential decision making; data processing, including filtering; clustering; blind signal separation and compression. Applications of ANNs comprise system identification and control (e.g., vehicle control, process control); game-playing and decision making (backgammon, chess, racing); pattern recognition (radar systems, face and other biometric identification, object recognition, etc.); sequence recognition (gesture, speech, handwritten text recognition); medical diagnosis; financial applications; data mining or knowledge discovery in databases; visualization and e-mail spam filtering.

A Bayesian network is a probabilistic graphical model that represents a set of random variables and their conditional dependencies.⁵ For example, a Bayesian network could represent the probabilistic relationships between diseases and symptoms, i.e., given the symptoms, the network can compute the probabilities of the presence of various diseases. Efficient algorithms exist that perform inference and learning in Bayesian networks. Bayesian networks are used for modeling knowledge in computational biology and bioinformatics (e.g., gene expression analysis, medicine, information retrieval, image processing, data fusion, engineering, gaming and law). ⁵ http://en.wikipedia.org/wiki/Bayesian_network

Referring again to FIG. 10(a), according to one embodiment of the present invention, analyzer 1030 trains on the N biometric data sequences 1010, after which its essential parameters, e.g., weights, statistics and other parameters (also referred to as markers or datasets), are captured and entered into functional dataset library 1040. The above process can be repeated for other applications of interest, e.g., recognition of cardiac or other physiological disorders, recognition of other biometric signatures such as retinal, facial or fingerprint signatures etc. Accordingly, functional dataset library 1040 is populated for the various applications of interest. The functional datasets of functional dataset library 1040 can be polymorphic, for example, of varying resolution or abstraction. Such polymorphic datasets could, for example, accommodate tradeoffs between processing time or complexity and confidence for a human identification application. This concept will be further discussed below.

Analyzer 1030 may be any of a variety of implementations, e.g., hardware-, firmware- or software-based, or combinations thereof; it may be implemented as a standalone device or algorithm, or may be part of a more comprehensive entity. Furthermore, variations of analyzer 1030 may be employed to build functional dataset library 1040. For example, both ANN and Bayesian analyzers 1030 may be employed to populate functional dataset library 1040, so as to offer an assortment of datasets of varying characteristics.

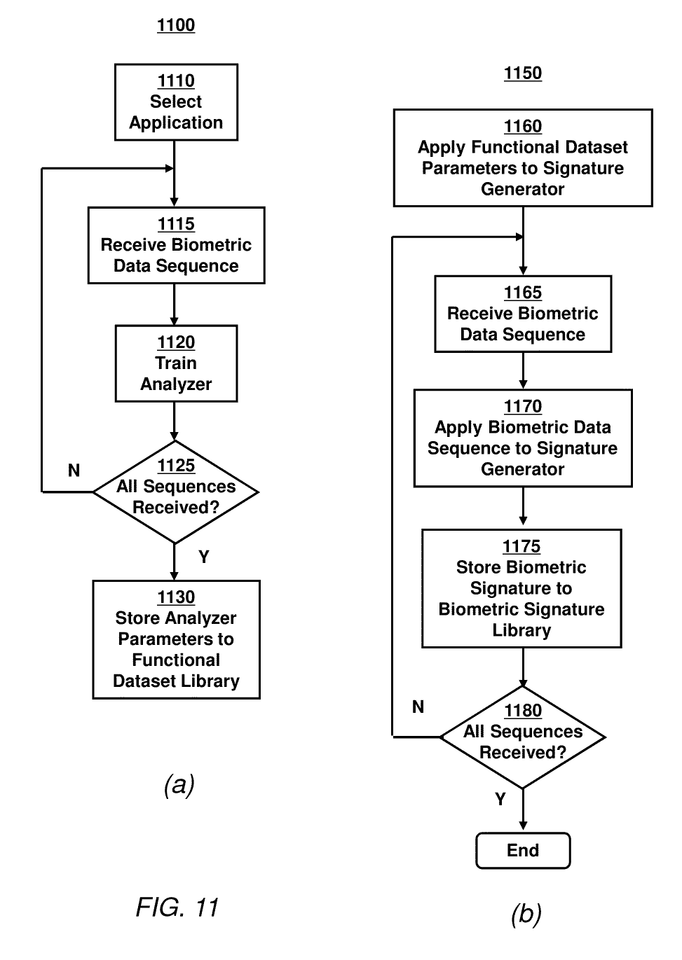

Referring now to FIG. 11, a flowchart 1100 depicts the process described above for the block diagram of FIG. 10(a) according to one embodiment of the present invention. An application of interest is selected 1110, after which a first biometric data sequence is received 1115 and applied 1120 to train analyzer 1030. If another biometric data sequence is available 1125, it is similarly applied; after all available biometric data sequences have been applied, the state of analyzer 1030 is captured by storing 1130 its dataset to functional dataset library 1040.

Referring now to FIG. 10(b), a functional block diagram is shown for a method or system for biometric identification. A biometric sensor 1050, such as a cardiac biometric sensor, produces one or more biometric data sequences 1060, which are fed to signature generator 1080. Biometric data sequences 1060 may or may not be related to corresponding sequences 1010. Signature generator 1080 is typically a fixed network such as, for example, a digital filter or fixed version of analyzer 1030. The structure of signature generator 1080 may or may not resemble that of analyzer 1030. For example, the architecture of analyzer 1080 may resemble that of analyzer 1030 with fixed weights replacing adaptive weights. Alternately, analyzer 1080 could be the same implementation (that is, same device or software) as analyzer 1030 with the normally adaptive weights frozen. In any event, signature generator 1080 is effectively configured using one or more of the functional datasets of functional dataset library 1040. According to one embodiment of the present invention, signature generator 1080 may be configured using one or more members of a set of polymorphic datasets of dataset library 1040. This might be done, for example, if it were of interest to balance processing time with the level of confidence in recognizing an individual based on a particular biometric data sequence 1060.

Biometric data sequences 1060 are fed to signature generator 1080 to generate biometric signatures 1090, each of which is indicative of the respective subject who generated the corresponding biometric data sequence 1060. Biometric signatures 1090 may be variously expressed, ranging from simple reference numbers indicating particular recognized individuals to vectors of probabilities, each member of such vector reflecting the probability that a respective biometric data sequence 1060 corresponds to a particular individual.

Referring again to FIG. 11, flowchart 1150 depicts the method described above for the block diagram of FIG. 10(b) according to one embodiment of the present invention. A functional dataset of interest from functional dataset library 1040 is selected and applied 1160 to signature generator 1080. A first biometric data sequence 1060 is received 1165 from biometric sensor 1050 and applied 1170 to signature generator 1080. The resultant biometric signature 1090 is stored 1175 to a biometric signature library. If another biometric data sequence is available 1180, it is similarly applied; after all available biometric data sequences have been applied, the process terminates. The biometric signature library may be paper-based, or may take the form of any type of magnetic, optical, flash memory etc. storage medium including, without limitation, those described above.

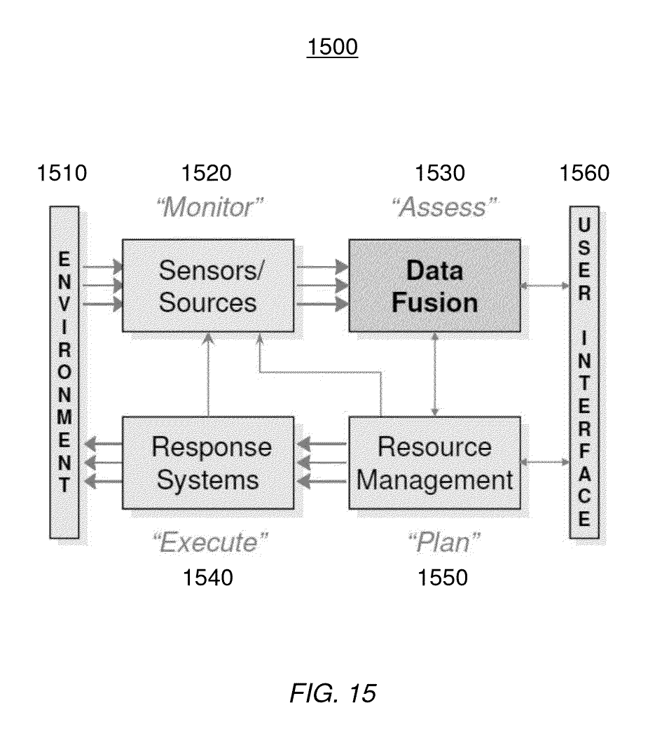

In general, sensors employed in M2M applications may produce voluminous amounts of data. Large systems such as SCADA or other industrial applications as well as military systems may employ hundreds or thousands of sensors. Handling the voluminous data produced requires methods and systems for automatically fusing, that is, combining the data. Referring now to FIG. 15, a methodology for sensor data fusion is shown. Environment 1510 may be an indoor environment, agricultural environment such as an orchard or vineyard, an industrial system or other type of environment to be monitored and possibly controlled. One or more sensors 1520 monitor various conditions or parameters pertinent to environment 1510 and report same to data fusion function 1530. Data fusion function 1530 may perform various functions such as, for example, formatting combining, abstracting, decimating, estimating etc., the results of which are forwarded to user interface 1560. Data fusion 1530 and user interface 1560 connect to resource management function 1550, which typically implements some strategy or algorithm for regulating or otherwise controlling resources within environment 1510. Resource management function 1550 may also control one or more of sensors 1520. Response system 1540 receives information from resource management function 1550 and accordingly controls one or more resources within environment 1510.

A simple example serves to inform the description of system 1500. Newer automobiles may include tire pressure sensors resident inside the tires which communicate wirelessly with a central management system within the automobile. If the detected pressure of any tire falls below a threshold, say 70 percent of nominal, a warning is issued to the driver. After the car is drive some distance, particularly in a colder climate, the pressure of the tire in question may rise to an acceptable level, and thus, the driver may have been needlessly alerted to take action. A more intelligent system could fuse tire pressure, temperature and distance information and exercise a prediction algorithm to alert the driver only if eventual pressure were predicted to fall outside the acceptable range.

### Application to Authentication

Authenticating an entity, such as a person, involves verifying that the person actually is who he or she purports to be. This has traditionally been commonly accomplished by use of a card or appliance such as passport, driving license or ID card. Modernly, appliances such as key fobs or personal digital appliances such as smart phones can be used in concert with wireless or optical communication links. In e-commerce applications, the identity of a user should be remotely verified, before communicating with him or her. A description of this can be found in Shahriar Mohammadi and Sanaz Abedi, which is referenced above.

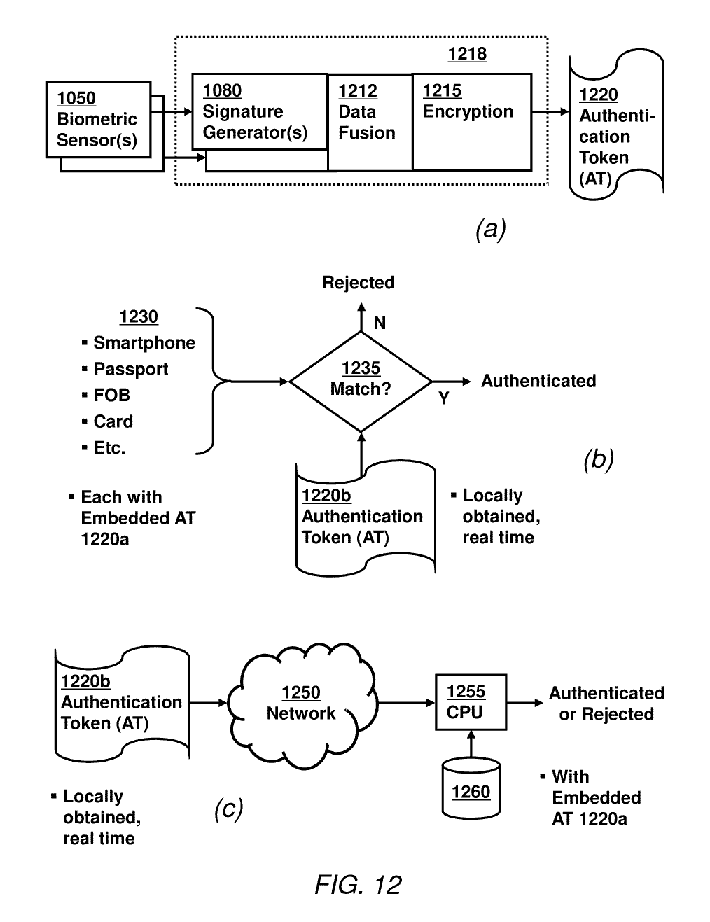

Referring now to FIG. 12, a method for authentication is shown according to one embodiment of the present invention. In FIG. 12(a), one or more biometric sensors 1050 generate corresponding biometric data sequences that feed one or more corresponding biometric signature generators 1080. For example, one biometric sensor 1050 may perform a retina scan, while another biometric sensor 1050 may generate a cardiac signature. Signature generator or generators 1080 each output corresponding biometric signatures. In the case where multiple biometric signatures are generated, they are combined by data fusion function 1212 to create a fused biometric signature. For example, data fusion function 1212 may append the individual biometric data signatures or, alternately, it may fuse the individual sequences in some more sophisticated fashion. The fused biometric signature is fed to encryption algorithm 1215, which encrypts the individual or fused biometric data sequence and outputs an authentication token 1220. Encryption algorithm 1215 may be proprietary, such that only the entity that designs it is capable of providing a matching or compatible encryption algorithm or a complementary decryption algorithm.

Typically, if multiple biometric sensors 1050 are employed, they would be exercised contemporaneously, although they could be exercised separately in time. For example, a new cardiac biometric data sequence might be obtained via from a corresponding biometric sensor 1050 and applied to a signature generator 1080. The resultant cardiac biometric signature could be fed to data fusion function 1212 along with a previously-obtained biometric signature derived from a retina scan. Functions 1080, 1212 and 1215 may in practice be implemented in hardware, software, firmware or combinations thereof. They comprise an authentication token generator 1218 that may be configured as an integrated entity, thereby providing immunity against compromise of the biometric signatures or fused biometric signatures created by generators 1080 or data fusion function 1212.

Referring now to FIG. 12(b), an authentication scheme is shown according to one embodiment of the present invention. Such a scheme might be used, for example, to allow a person to enter a restricted area. The person requesting entry presents an appliance 1230 that contains an embedded AT 1220a. Embedded AT 1220a would have been generated previously through cooperation of the bearer using the method of FIG. 12(a) or equivalent. Appliance 1230 could be, for example, a personal digital appliance or key FOB that wirelessly transmits AT 1220a. Appliance 1230 could alternately be a passport or identification card with an embedded device that bears the AT when illuminated or stimulated by radio waves or other forms of energy. Persons skilled in the art will appreciate that many alternate embodiments of appliance 1230 are possible.

The bearer presents appliance 1230 to a security station, kiosk etc., which in scans the bearer to generate a local AT 1220b using the method of FIG. 12(a). The security station etc. or some associated device or equipment then determines 1235 whether embedded AT 1220a matches locally generated AT 1220b. If a match is determined, the presenter is granted access; otherwise, access is denied or some alternate action is taken.

According to another embodiment of the present invention, appliance 1230, rather than the security station, kiosk etc., scans the bearer to generate AT 1220b. Thus in this embodiment, appliance 1230 both contains obtains embedded AT 1220a and produces locally generated AT 1220b. Appliance 1230 then transmits embedded AT 1220a and locally generated AT 1220b to the security station, kiosk etc.

Now referring to FIG. 12(c), an alternate authentication scheme is shown according to another embodiment of the present invention. The person requesting access agrees to be scanned such that locally-obtained AT 1220b is generated and transmitted over a network 1250. The transmitted AT 1220b is compared by CPU 1255 with an embedded AT 1220a stored in memory 1260. If CPU 1255 detects a match, the requestor is granted access; otherwise, access is denied or some alternate action is taken. CPU 1255 may be any device or algorithm capable of performing the appropriate operations, such as, for example, a software algorithm executing on a processor 722, a simple hardware logic device, and so on. Thus, in this embodiment, no appliance 1230 is required.

### E-Commerce Applications

The authentication schemes discussed above can be employed in a variety of e-commerce applications. Now referring to FIG. 9, application to an automatic teller machine (ATM) 910 is shown. Traditionally, ATMs function by accepting a card 930 having information encoded in a magnetic stripe, embedded chip or other medium carried by the card. Prior to first using the card, the card owner selects a personal identification number (PIN) which is encoded into the card medium by the providing bank or institution. During use, the card owner swipes or inserts the card into the ATM and types or otherwise enters the PIN into the ATM. If the ATM detects a match, the card owner is authorized to make transactions. This approach suffers from several drawbacks. The user may lose or have stolen the card or forget the password. Identity thieves may surreptitiously physically install readers that an unsuspecting user would not be aware of that read and store or wirelessly transmit card information.

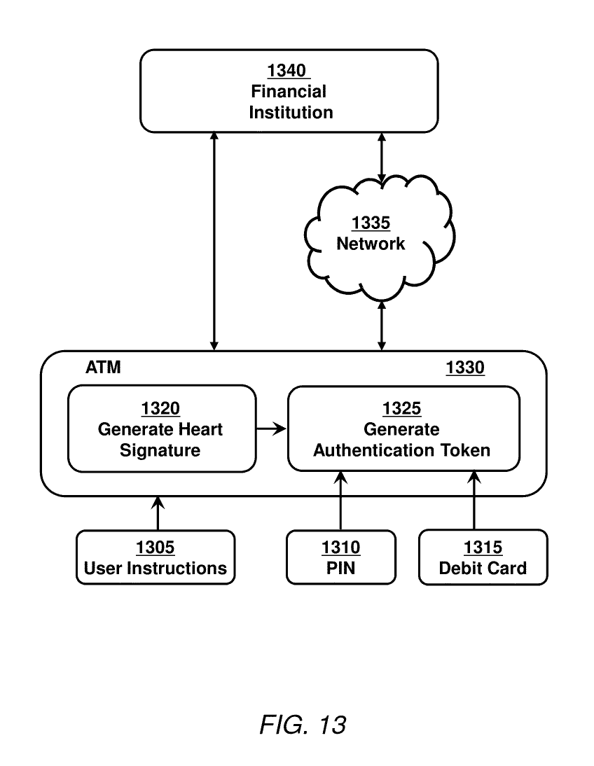

ATM security can be enhanced by adding biometric-based authentication such as cardiac biometric identification 920. Referring to FIGS. 9 and 13, according to one embodiment, the customer would insert a card such as a debit card 1315 and enter a PIN 1310, after which a cardiac biometric sensor housed within ATM 1330 would generate a cardiac biometric signature 1320. The PIN, debit card information and cardiac biometric signature would be used to generate 1325 a local AT. This local AT would be forwarded directly or via network 1335 to financial institution 1340, along with customer instructions 1305, such as request to withdraw funds, make deposit, check balance etc. Financial institution 1340 would receive the transmitted information and then attempt authentication based on an embedded token stored or otherwise obtained by financial institution 1340. Upon successful authentication, financial institution 1340 would return appropriate commands and information to ATM 1330 to perform the requested transactions.

According to another embodiment of the present invention, an appliance such as a smart phone or other personal digital appliance, rather than ATM 910, contains a scanning apparatus that scans the bearer to generate 1320 a biometric signature, such as a cardiac, retina, facial or fingerprint biometric signature. The personal digital appliance then wirelessly transmits the chosen biometric signature to ATM 910 or other receiving device. Such an approach can offer a choice of biometrics and enables the scanning apparatus to be calibrated or tuned to the true owner of the personal digital appliance. Closer proximity of the scanning apparatus to the user's retina, face, heart etc. could improve the fidelity of the captured biometric data. Advantageously, the probability of positively authenticating the true owner could be maximized without limiting the effectiveness of rejecting an impostor.

According to yet another embodiment of the present invention, the user's identity can be authenticated without use of an appliance. The user need only undergo a biometric scan, and thus authentication is based only upon the resultant biometric signature, the resultant generated AT and comparison with the embedded (stored) AT.

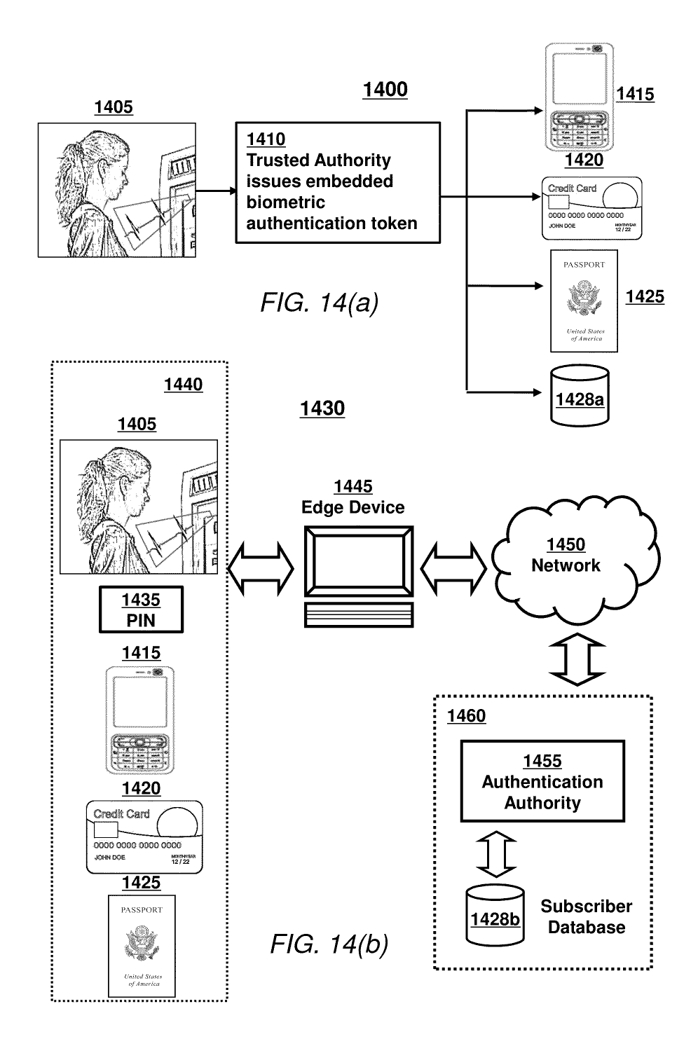

Referring now to FIG. 14, a method for conducting general e-commerce transactions is depicted. As shown in FIG. 14(a), a user 1405 visits 1410 a Trusted Authority (TA) which uses the methodology described above to perform a biometric scan of the user to obtain a biometric data sequence. Using the methods described above, the TA generates one or more embedded authentication tokens (ATs). The embedded ATs may be embedded into an appliance of the user's choice, such as a personal digital appliance 1415, a credit, debit or other type of card 1420 or a passport 1425. It will be appreciated that the AT may be embedded within an indefinite number of other types of appliances, such as, for example, a personal computer memory, a FOB or other access device, a badge, a data storage device such as a CDROM, flash memory and so on. The TA also stores a corresponding embedded AT into a database 1428a.

Referring now to FIG. 14(b), an Authentication Authority 1455 has access to a subscriber database 1428b that also contains the embedded ATs. Subscriber database 1428b may contain data copied from database 1428a, or it may be identical to database 1428a. Authentication Authority 1455 is connected to network 1450. When user 1405 desires to make a transaction, such as a purchase from a vendor or a transaction via a broker via an edge device 1445, he or she undergoes a compatible biometric scan via edge device 1445 or a related peripheral device. Edge device 1445 may be any device with a human interface, such as, for example, a personal computer, a personal digital appliance such as a smart phone, a kiosk, and so on. The edge device generates the corresponding biometric data sequence from the biometric scan and processes it as described above to produce a local AT. Edge device 1445 then obtains from the presented appliance the embedded AT originally provided by the trusted authority.

Edge device 1445 may obtain other user data such as a PIN 1435 or other information such as location data provided by a Global Positioning System (GPS) device. From the data collected, edge device 1445 may generate a local checksum to provide a first authentication of user 1405. If such first authentication is performed and is successful, edge device 1445 then transmits the local AT, embedded AT and optionally the local checksum to Authentication Authority 1455 over a network 1450. Authentication Authority 1455 determines whether there is a match between the information received from edge device 1445 and the information stored in database 1428b. If there is a match, Authentication Authority 1455 returns to edge device 1445 and/or to the e-Commerce vendor or broker a confirmation via network 1450. User 1405 then completes the transaction.

It will be appreciated that while edge device 1445 and appliances such as personal digital appliance 1415 have been described as separate entities, they may in fact be the same. As was discussed previously in the context of the ATM example, a personal digital appliance 1415 could similarly conduct the biometric scan in place of edge device 1445. A personal digital appliance 1415 could also be used to conduct the various e-Commerce transactions of interest.

According to yet another embodiment of the present invention, the user's identity can be authenticated without use of an appliance. As with the ATM application above, user 1405 need only undergo a biometric scan, and thus authentication is based only upon the resultant biometric signature, the resultant generated local AT and comparison with the embedded AT within subscriber database 1428b.

The above methodology for e-commerce application offers a number of significant advantages. The user is authenticated based on his or her unique biometric characteristics, and thus risk of compromise based on lost or stolen passwords or PINs is eliminated. Biometric scanning can be accomplished either by infrastructure equipment or by a personal digital appliance such as a smart phone, as such appliance may be equipped with a biometric scanning device. Other applications resident on the personal digital appliance can securely process the requisite transactions. The user's identity is kept secure, and thus transaction security is improved. If the personal digital appliance is lost or stolen, the risk to the owner of compromise of critical personal information (such as a stored PIN or digital certificate) is reduced or eliminated.

### Energy Management Applications

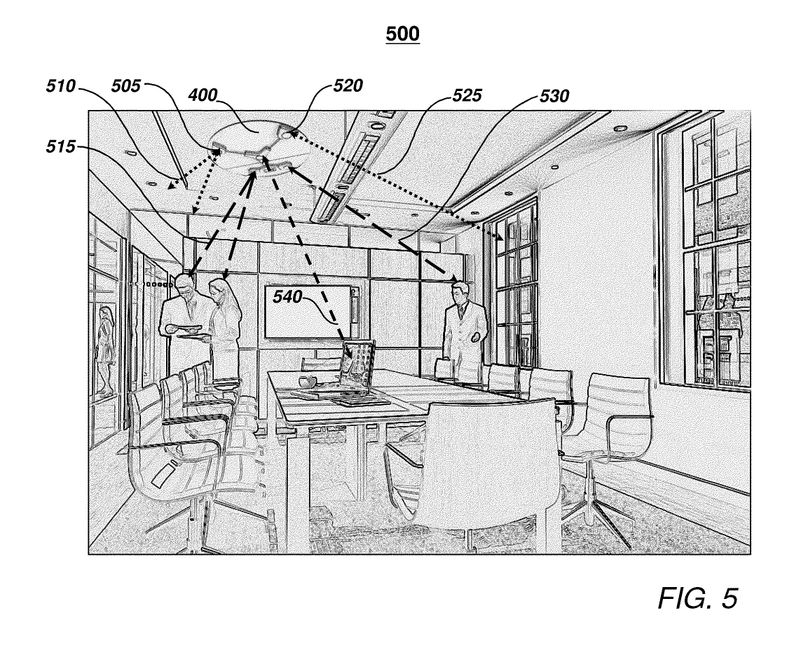

Referring now to FIG. 5, a method for managing resources within a room or area of a building according to one embodiment of the present invention is shown. The building includes a central building management system (BMS) that controls resources such as heating, air conditioning, ventilation, security etc. Each resource has one or more resource control parameters, such as temperature set point, carbon dioxide set point and so on. The control parameters may pertain to the building as a whole or may be on a room or area basis. The BMS resources similarly have resource status parameters that reflect current conditions, such as current temperature, humidity etc. The BMS may further comprise a list of persons that inhabit the building and their individual preferences, such as desired room temperature, light level and so on. The room may be inhabited or uninhabited.

A sensor pod 400 as described above is mounted at a convenient location within the room or area, for example, at a substantially central point on the ceiling. Sensor pod 400 comprises a number of individual sensors, such as temperature sensor 505 oriented to sense heat in direction 510, a biometric sensor or sensors oriented to obtain biometric signatures along directions 515 and 530, and ambient light sensor 520 oriented to sense light in direction 525. Sensor pod 400 can also enable wireless communications for computers in the area, as shown by wireless link 540. Sensor pod 400 includes another communications link that may be uni- or bi-directional, and serves to relay sensor and other data as required to the BMS and information technology (IT) infrastructure. The types of sensors and their orientations and functions as described are merely illustrative, and many other variations are possible.

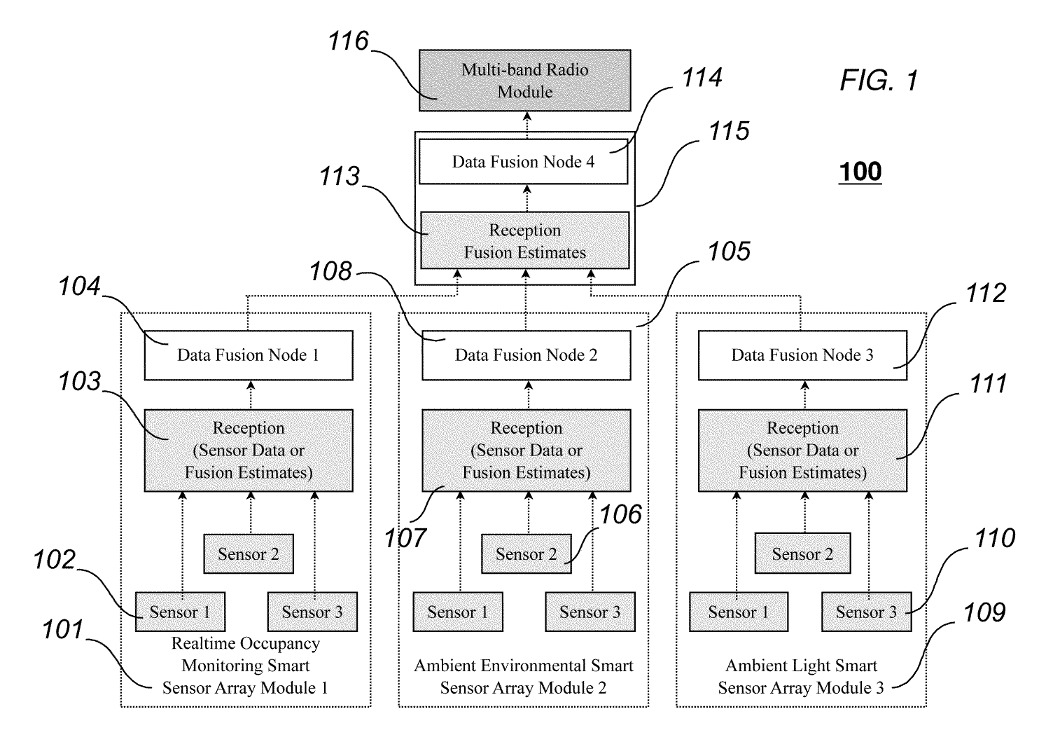

Referring now to FIG. 1, a sensor pod information processing system 100, also referred to as a data fusion platform, is shown according to one embodiment of the present invention. Sensor pod information processing system 100 may be physically located within sensor pod 400, or it may be remotely located. The various sensors 102 that return biometric information forward such information to reception function 103, which combines, refines, decimates or reduces information as appropriate. For example, if multiple sensors receive biometric information pertaining to the same person, redundant information may be discarded. Alternately, information from multiple sensors pertaining to the same person may be fused, or combined, such that the accuracy or fidelity of the resulting signal is improved, and thus the likelihood of correctly identifying the individual is enhanced. In this manner, multiple inexpensive sensors can effectively function comparably to a lesser number of more expensive sensors. Reception function 103 forwards the processed information to data fusion node 104. The above functions comprise Realtime Occupancy Monitoring Smart Sensor Array Module 101.

Ambient Environmental Smart Sensor Array Module 105 and Ambient Light Smart Sensor Array Module 109 similarly process information from environmental sensors 106 and ambient light sensors 110. Reception functions 107 and 111 similarly process and forward corresponding information to data fusion node 108 and 112, respectively.

The outputs of data fusion nodes 104, 108 and 112 are fed to reception fusion estimate function 113, which also combines the information and forwards to data fusion node 114. Data fusion node 114 then refines, decimates or reduces the received information as appropriate. For example, if a particular area of a room lacks a temperature sensor but includes an ambient light sensor that senses light incoming from an exterior window, a temperature differential relative to that sensed in a nearby area can be estimated. If no biometric sensor senses the presence of persons in the area, a summary indication of same can be forwarded rather than more detailed information such as Doppler radar echoes from inanimate objects. Furthermore, in the latter case, ambient temperature and lighting data can be discarded, as the BMS may simply shut down heating or air conditioning to the uninhabited area or room. During an emergency or disaster such as a fire or earthquake, normal communication of environmental data may be suspended to avoid overloading communication channels that may be carrying unusually high levels of data as a consequence of the emergency or disaster.

The output of data fusion node 114 may be forwarded to and from the BMS via wireline, or optionally may be forwarded to multi-band radio module 116 for wireless communication to and from the BMS. The output format of data fusion node 114 may be serial, parallel or combinations thereof. Optional multi-band radio module 116 may also accommodate data communications to and from devices in the room or area, such as personal computers, personal digital appliances and the like.

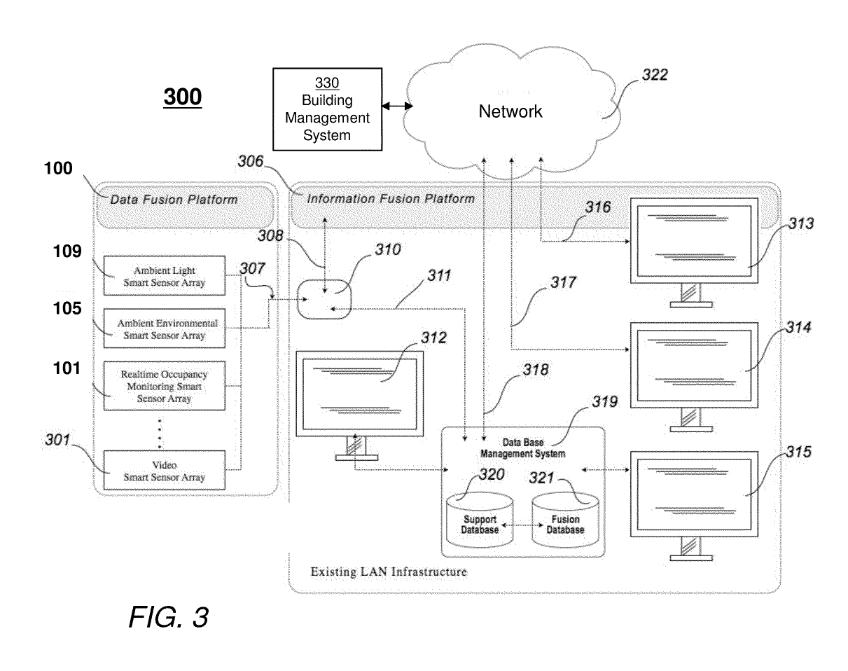

Referring now to FIG. 3, a data and information fusion platform 300 is shown, which includes data fusion platform 100 and information fusion platform 306. Information fusion platform 306 receives sensor information from and sends commands to data fusion platform 100 via node 310, and it serves as a liaison between data fusion platform 100 and BMS 330.

Information fusion platform 306 comprises database management system 319, which further comprises a support database 320 and a fusion database 321. Support database 320 may include information regarding a variety of things such as building resources (heating, air conditioning, etc.), the identities of people that may inhabit the building and their biometric profiles and personal preferences, energy management profiles such as temperature setpoints according to daily, weekly and holiday schedules, demand response profiles, and so on. Fusion database 321 may include information regarding the manner in which information from multiple sensors is to be combined, instructions on how to handle failure of sensors, etc.

Information fusion platform 306 may further serve as a liaison for human operators. In such case, one or more status/control stations 312, 313, 314 and 315 may be continually or intermittently staffed by operators, or may simply serve as monitors to be occasionally checked. These monitors may provide such functions or information as sensor monitoring, including sensor fusion activity, energy usage and management profiles, system activity monitoring and alerts upon alarms or unusual activity, security status and power grid information. Status/control stations 312, 313, 314 and 315 may also enable control over any or all building resources, security systems etc.

Data fusion platform 100 and information fusion platform 306 may interface with personal digital appliances such as smart phones. Such appliances may provide a range of utility such as serving as environmental or biometric sensors or control terminals, providing personal location data via Global Positioning System (GPS) sensors, and so on. Such an appliance may already be in use by individuals for other purposes, and so the system may thereby benefit from such utility at minimal or no marginal expense.

Advantageously, data and information fusion platform 300 optimizes the balance between providing adequate comfort and support on the one hand, and minimizing energy usage on the other. Consideration is given to the building's inhabitants and their personal preferences. Variables such as changing external light, real-time demand response profiles and changes in staffing and room occupancy may be taken into consideration. Data and information fusion platform 300 may be integrated with other systems such as building security etc.

Those of skill in the art will appreciate additional alternative methods, apparatus and applications for M2M and biometric systems. Thus, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

1. A method for authenticating a person's identity, the method comprising:
Illuminating the person with an incident electromagnetic energy;
Receiving a reflected electromagnetic energy produced by a reflection of said incident electromagnetic energy from the person's body, said reflected electromagnetic energy bearing a modulation relative to said incident electromagnetic energy and resulting from a motion of the person's anatomy;
Generating a first data sequence based on said modulation;
Generating an authentication token from said first data sequence; and
Comparing said authentication token to an embedded token to determine a match, the embedded token corresponding to the person.

2. The method of claim 1, further comprising transmitting the authentication token over a network prior to said comparing said authentication token to said embedded token.

3. The method of claim 1, wherein said generating an authentication token from said data sequence comprises encrypting said data sequence.

4. The method of claim 1, further comprising:
Receiving a second data sequence generated by a biometric sensor;
Wherein said authentication token is generated from said first data sequence and said second data sequence.

5. The method of claim 4, wherein said biometric sensor is one of an electrocardiogram sensor, a laser Doppler vibrometry sensor, a retina scan sensor, a facial feature sensor and a fingerprint sensor.

6. The method of claim 1, wherein said electromagnetic energy is a radio frequency electromagnetic energy.

7. A method for determining a person's identity, the method comprising:
Illuminating the person with an incident electromagnetic energy;
Receiving a reflected electromagnetic energy produced by a reflection of said incident electromagnetic energy from the person's body, said reflected electromagnetic energy bearing a modulation relative to said incident electromagnetic energy and resulting from a motion of the person's anatomy;
Generating a first data sequence based on said modulation;
Generating an authentication token from said first data sequence; and
Comparing said authentication token to a plurality of embedded tokens to determine a match, said plurality of embedded tokens corresponding to a plurality of persons.

8. The method of claim 7, further comprising transmitting the authentication token over a network prior to said comparing said authentication token to said embedded token.

9. The method of claim 7, wherein said generating an authentication token from said data sequence comprises encrypting said data sequence.

10. The method of claim 7, further comprising:
Receiving a second data sequence generated by a biometric sensor;
Wherein said authentication token is generated from said first data sequence and said second data sequence.

11. The method of claim 10, wherein said biometric sensor is one of electrocardiogram sensor, a laser Doppler vibrometry sensor, a retina scan sensor, a facial feature sensor and a fingerprint sensor.

12. The method of claim 7, wherein said electromagnetic energy is a radio frequency electromagnetic energy.

13. A method of conducting a transaction involving a person, the method comprising:
Scanning the person to generate a first biometric signature, said scanning comprising illuminating the person with electromagnetic energy and processing a reflection of said electromagnetic energy;
Encrypting said first biometric signature to produce an embedded authentication token;
Requesting the transaction by the person;
Scanning the person in response to said requesting a transaction to generate a second biometric signature;
Encrypting said second biometric signature to produce a local authentication token;
Generating a comparison result by comparing said local authentication token and said embedded authentication token; and
Executing the transaction if said comparison result is a positive comparison result.

14. The method of claim 13, further comprising presenting by the person an appliance containing the embedded authentication token.

15. The method of claim 13, wherein the first or second biometric signature is derived from one or more of a radio frequency Doppler heart sensor, an electrocardiogram sensor, a laser Doppler vibrometry sensor, a retina sensor, a facial sensor and a fingerprint sensor.

16. The method of claim 13, wherein at least one of the local authentication token and the embedded authentication token is transmitted over a network.

17. The method of claim 14, wherein said scanning the person to generate the second biometric signature is performed by the appliance.

18. The method of claim 14, wherein the appliance is one of a personal computer, a personal digital appliance, a passport, a FOB, and a card.

19. A method of generating a biometric signature, the method comprising:
Receiving a biometric data sequence generated from a biometric sensor; and
Applying the biometric data sequence to a biometric signature generator to generate the biometric signature, the biometric signature generator configured using a biometric functional dataset, the biometric functional dataset describing biological traits of one or more persons;
wherein the biometric functional dataset is derived by:
applying a plurality of biometric data sequences to an analysis adaptive network;
exercising the analysis adaptive network with the applied plurality of biometric data sequences until the analysis adaptive network has substantially converged; and
obtaining the biometric functional dataset from the substantially converged analysis adaptive network.

20. A method of managing one or more resources within an environment, the environment comprising a person and one or more environmental sensors, each environmental sensor supplying a corresponding environmental descriptor, and each resource having a corresponding resource control parameter that determines an aspect of the resource, the method comprising:
Receiving one or more resource status parameters, each resource status parameter associated with a corresponding resource;
Receiving an identity token associated with the person;
Determining a preference based on the identity token; and
Controlling at least one resource control parameter based on at least one environmental descriptor and on at least one resource status parameter and on the preference.

21. The method of claim 20, wherein the identity token is determined based on a biometric data sequence.

22. The method of claim 20, wherein said determining a preference comprises looking up the preference in a lookup table based on the identity token.

23. The method of claim 20, wherein at least one resource control parameter is an environmental resource control parameter and at least one resource status parameter is an environmental resource status parameter.

24. An apparatus for determining a person's identity, the apparatus comprising:
A sensor for illuminating the person with an incident electromagnetic energy and for receiving a reflected electromagnetic energy produced by a reflection of said incident electromagnetic energy from the person's body, said reflected electromagnetic energy bearing a modulation relative to said incident electromagnetic energy and resulting from a motion of the person's anatomy;
A sensor data processor for receiving an output of said sensor and generating a first data sequence based on said modulation;
A token processor for generating an authentication token from said first data sequence; and
A matcher processor for comparing said authentication token to a plurality of embedded tokens to determine a match, said plurality of embedded tokens corresponding to a plurality of persons.

25. An apparatus for authenticating a person's identity, the apparatus comprising:
A sensor for illuminating the person with an incident electromagnetic energy and for receiving a reflected electromagnetic energy produced by a reflection of said incident electromagnetic energy from the person's body, said reflected electromagnetic energy bearing a modulation relative to said incident electromagnetic energy and resulting from a motion of the person's anatomy;
A sensor data processor for receiving an output of said sensor and generating a first data sequence based on said modulation;
A token processor for generating an authentication token from said first data sequence; and
A matcher processor for comparing said authentication token to an embedded token to determine a match, the embedded token corresponding to the person.

26. An apparatus for generating a biometric signature of a person, the apparatus comprising:
An analyzer for receiving a plurality of biometric data sequences and generating a corresponding biometric functional dataset, said plurality of biometric data sequences and said biometric functional dataset describing biometric traits; and
A biometric signature generator for receiving a biometric data sequence corresponding to the person and for generating the biometric signature, the biometric signature generator configured using said biometric functional dataset;
wherein said analyzer generates the corresponding biometric functional dataset by:
applying said plurality of biometric data sequences to an analysis adaptive network;
exercising the analysis adaptive network with said plurality of biometric data sequences until the analysis adaptive network has substantially converged; and
generating the biometric functional dataset from the substantially converged analysis adaptive network.
